(19) United States
(12) Patent Application Publication
(10) Pub. No.: US 2007/0244973 A1
(43) Pub. Date: Oct. 18, 2007

(54) Accessing web based email applications

(75) Inventor: Larry B. Pearson, San Antonio, TX (US)

Correspondence Address: GREENBLUM & BERNSTEIN, P.L.C., 1950 ROLAND CLARKE PLACE, RESTON, VA, 20191, US

(73) Assignee: SBC Knowledge Ventures, L.P., Reno, NV (US)

(21) Appl. No.: 11/402,918

(22) Filed: Apr. 13, 2006

(51) Int. Cl. G06F 15/16

(52) U.S. Cl. 709/206

(57) ABSTRACT

A system for sending an email through a web based email provider while using a web application includes a web application server and a web based email application server. The web application server displays a web page at a client having at least one selectable link, receives an instruction from the client requesting an email through selection of the selectable link, creates a redirect message for accessing the web based email provider, and sends the redirect message to the client. The web based email application server receives the redirect message, displays an email composition web page at the client, receives a completed email from the client, and sends the completed email to an email server for delivery.

### BACKGROUND

1. Field of the Disclosure

The present disclosure relates to securely accessing and utilizing web based email applications from other web applications.

2. Background Information

Various web based services, such as Voice over Internet Protocol (VoIP), provide personal address books or similar contact information for the convenience of the users. Often, the contact information provides click-to-call functionality, as well as underlying network infrastructure for call control functions. For example, features such as blocking calls and routing calls based on Caller ID information may be tied to address book data to identify and classify callers. Also, the identification and classification may be used as input in deciding how calls are handled.

Typically, such web based services do not include an email component, but rather rely on the email capabilities of the user interface implementing the web service. For example, to support a click-to-email function while in the web based service, the user interface wraps a hyperlink around an email icon, which activates the default mail client program. Accordingly, when the user clicks on the link, the default client based email program, such as Microsoft's Outlook program or Outlook Express program, is launched with the recipient's address filled in. The user then fills in the subject and body of the email and sends to the intended recipient.

However, users that rely on web based email programs, such as Yahoo Mail, HotMail, Google Gmail and the like, are unable to experience the benefits of linking to his or her email program since they are not PC email client configured. Additionally, some web based email providers do not provide customer interfaces necessary to support PC email clients. Given that alliances, partnerships and mergers are being created that integrate products from telephone service providers, cable companies, satellite companies, Internet Access Providers, and Internet Service Providers, there is a need for a simple, uniform secure click to email solution.

### BRIEF DESCRIPTION OF THE DRAWINGS

The present disclosure provides the detailed description that follows by reference to the noted drawings by way of non-limiting examples, in which like reference numerals represent similar parts throughout several views of the drawings, and in which:

FIG. 1 shows an exemplary general computer system that includes a set of instructions for performing processing, according to an aspect of the present disclosure;

FIG. 2 shows an exemplary block diagram, according to an aspect of the present disclosure;

FIG. 3 shows an exemplary system ladder diagram, according to an aspect of the present disclosure;

FIG. 4 shows an exemplary screen shot of a configurations settings web page, according to an aspect of the present disclosure;

FIG. 5 shows an exemplary screen shot of a web application contact web page, according to an aspect of the present disclosure; and

FIG. 6 shows an exemplary screen shot of a web based email web page, according to an aspect of the present disclosure.

### DETAILED DESCRIPTION

The present disclosure relates to a click to email feature that enables a subscriber or the user of a web application, such as a VoIP service, to click on an email link and generate an email through a web based email application, for example, provided by a party (e.g., Yahoo Mail, HotMail, Google Gmail) other than the web application service provider. The web application service provider and the web based email application service provider are affiliated for purposes of integrating the respective services. The user interface, such as a personal computer (PC) or other graphical user interface (GUI), includes configuration settings implemented by the web application, as well as icons or links activating the interface to the web based email application. An embodiment also provides an option for the user to select either the web based email application or a client based email program, such as Microsoft Outlook.

The web application may provide a number of ways by which to interface with the web based email application. For example, in one embodiment of the disclosure, a VoIP service provider includes a personal address book that is populated by the user. The address book entries indicate names and associated telephone numbers, email addresses and other contact information. The VoIP service includes the capability of clicking on an icon to initiate a VoIP telephone call to a selected contact, which feature may be implemented through the VoIP web application. Further, the VoIP service includes an icon for initiating an email to the selected contact through a web based email provider. Because the VoIP web application itself does not include email capability, the VoIP service includes a link to the web based email provider, as discussed above. In response to the user clicking on the link, the web based email provider generates the email composition page displayed at the user interface, for example, as an overlay or popup window, and subsequently sends the email without the user having to exit the VoIP service or otherwise initiate a separate email program.

In view of the foregoing, the present disclosure, through one or more of its various aspects, embodiments and/or specific features or sub-components, is thus intended to bring out one or more of the advantages as specifically noted below.

An aspect of the present disclosure provides a computer readable medium that stores a program for sending an email through a web based email provider from a web application. The web application may include, for example, a Voice over Internet Protocol (VoIP) application. The computer readable medium includes a providing code segment that provides a web page of the web application to be displayed at a client of a user. The web page has at least one selectable link to the web based email provider. A receiving code segment of the computer readable medium receives an instruction requesting an email. The instruction is initiated by selecting the selectable link. A creating code segment creates a redirect message for accessing the web based email provider, and a sending code segment sends the redirect message to the client, which forwards the redirect message to the web based email provider to obtain an email composition web page. The computer readable medium may also include a retrieving code segment that retrieves configuration settings from at least one of a database or the client. The configuration settings include, for example, an identification of the web based email provider.

The web page of the web application may include an address book, such that the at least one selectable link corresponds to a contact listed in the address book. Also, the email composition web page may include a sender field preaddressed with a sender email address of the user and a recipient field preaddressed with a recipient email address corresponding to the contact. When the web application is a VoIP application, the web page of the web application may further include a second selectable link corresponding to a telephone number of the contact listed in the address book. Accordingly, the computer readable medium may further include a VoIP receiving code segment that receives a VoIP instruction from the client requesting a telephone connection to the contact by selection of the second selectable link, and a VoIP initiating code segment that initiates the telephone connection to the contact in response to the VoIP instruction.

Another aspect of the present disclosure provides a system for sending an email through a web based email provider while using a web application. The system includes a web application server and a web based email application server. The web application server displays a web page at a graphical user interface (GUI) having at least one selectable link, receives an instruction requesting an email through selection of the at least one selectable link, creates a redirect message for accessing the web based email provider, and sends the redirect message to the GUI. The web based email application server receives the redirect message from the GUI, displays an email composition web page at the GUI, receives a completed email, and sends the completed email to an email server for delivery. The web application server may further retrieve at least one configuration setting from a database, where the configuration setting includes an identification of the web based email provider. The system may also include an authentication server that provides authentication data corresponding to the web application and the web based email application. The authentication server enables, for example, single sign-on capability for the web application and the web based email application.

The web page of the web application may include a list of contacts, and the at least one selectable link may correspond to an email address of one of the listed contacts. The web application may be a VoIP application, and the web page of the web application may further include a second selectable link corresponding to a telephone number of one of the listed contacts. The email composition web page may include a sender field preaddressed with a sender email address and a recipient field preaddressed with a recipient email address corresponding to the contact.

Another aspect of the present disclosure provides a method for sending an email through a web based email provider, while using a web application. The method includes providing a web page of the web application to be displayed at a graphical user interface (GUI) of a client of a user, the web page having at least one selectable link to the web based email provider; receiving an instruction requesting an email, the instruction being initiated by a selection of the at least one selectable link; creating a redirect message for accessing the web based email provider; and sending the redirect message to the client, which forwards the redirect message to the web based email provider to obtain an email composition web page. The method may further include retrieving configuration settings from the client or a database. The configuration settings have an identification of the web based email provider.

The at least one selectable link may correspond to a contact listed on the web page. Also, when the web application includes a VoIP application, the web application further displays at least one VoIP selectable link corresponding to a telephone number of the contact listed on the web page. A telephone connection may then be initiated to the contact in response to selection of the at least one VoIP selectable link.

The various aspects and embodiments of the present disclosure are described in detail below.

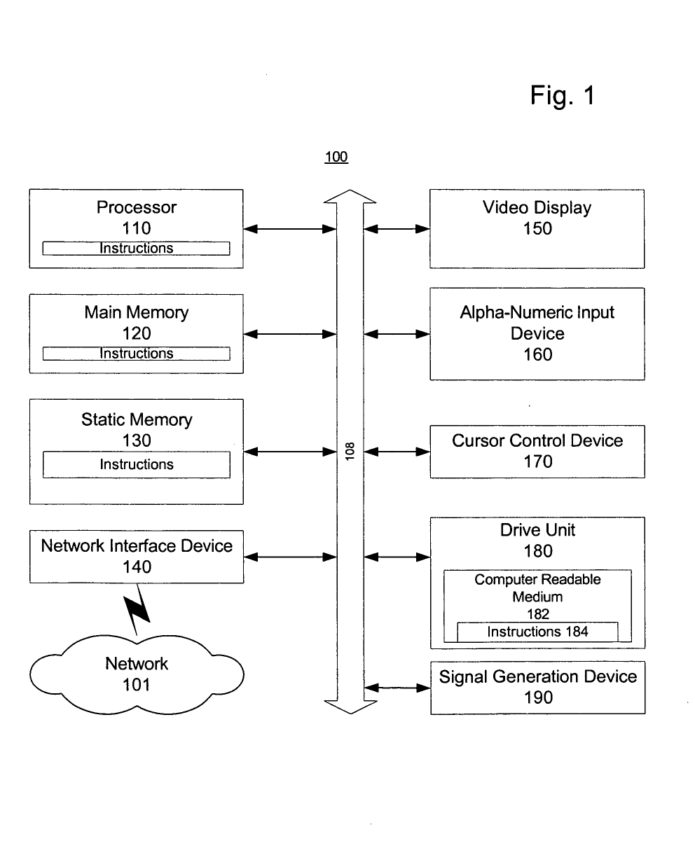

Referring to FIG. 1, a description is now provided of an illustrative embodiment of a general computer system 100, on which the web based email application integration process can be implemented. The computer system 100 can include a set of instructions that can be executed to cause the computer system 100 to perform any one or more of the methods or computer based functions disclosed herein. The computer system 100 may operate as a standalone device or may be connected, e.g., using a network 101, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, e.g., a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g., software, can be embedded. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Using a general computer system as shown in FIG. 1, a process for interfacing with web based email applications to efficiently compose and send emails using, for example, contact information from an unrelated web application may be provided. The system of FIG. 1 can also operate as various elements within the network. For example, a program implementing the disclosure may be loaded and executed on one or more web servers. Alternatively, the program may be run locally on a PC or a server dedicated to a particular user group or region.

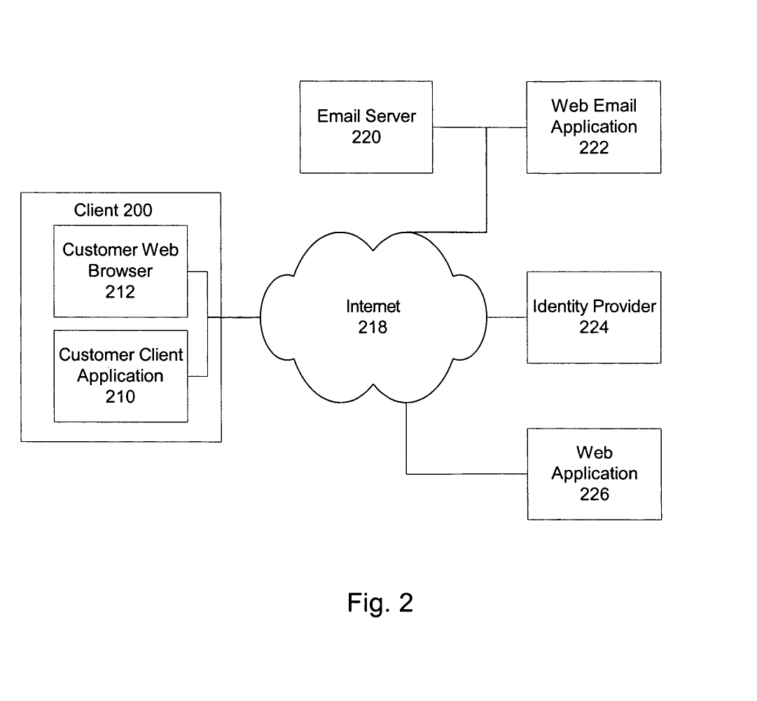

The block diagram of FIG. 2 provides a high-level architecture of an exemplary embodiment of the present disclosure. The user or customer accesses a web application 226 from a client 200 through the Internet 218. The client 200 may include a graphical user interface, such as a PC, running a customer web browser 212 and a customer client application 210. As discussed above, the web application 226, running for example on a web server maintained by the web application service provider, may be a VoIP service, in which case the client application 210 may be a VoIP application on the client 200 or a VoIP telephone (not shown) separate from the client 200. Configuration information needed by the VoIP service or other web application may be stored within the web application 226 or may be provided through the client 200. Implementing the disclosed click to email service from a VoIP application (or other web application) to a web based email application may require a business relationship between the two providers, at least to coordinate the methodology to transfer web pages and to implement security, enabling integration of the two applications.

Also connected to the Internet 218 are two web servers associated with a web based email service, the email server 220 and the web email application 222, both of which may be associated with an Internet Service Provider (ISP). The email server 220 has interfaces supporting PC email clients. The web email application 222 provides a web based email application. While the two servers are normally provided by the same ISP, they may be provided by different providers.

FIG. 2 also depicts an identity provider (IDP) 224, which may be included in various embodiments, without departing from the scope and spirit of the present disclosure. For example, the web application provider may include Federated Identity Management (FIM) to support single sign-on (SSO) between the web application provider and its affiliated partners. For example, a VoIP provider and a web based email provider may use FIM to enable SSO for the user to avoid participating in multiple log-in and authentication processes.

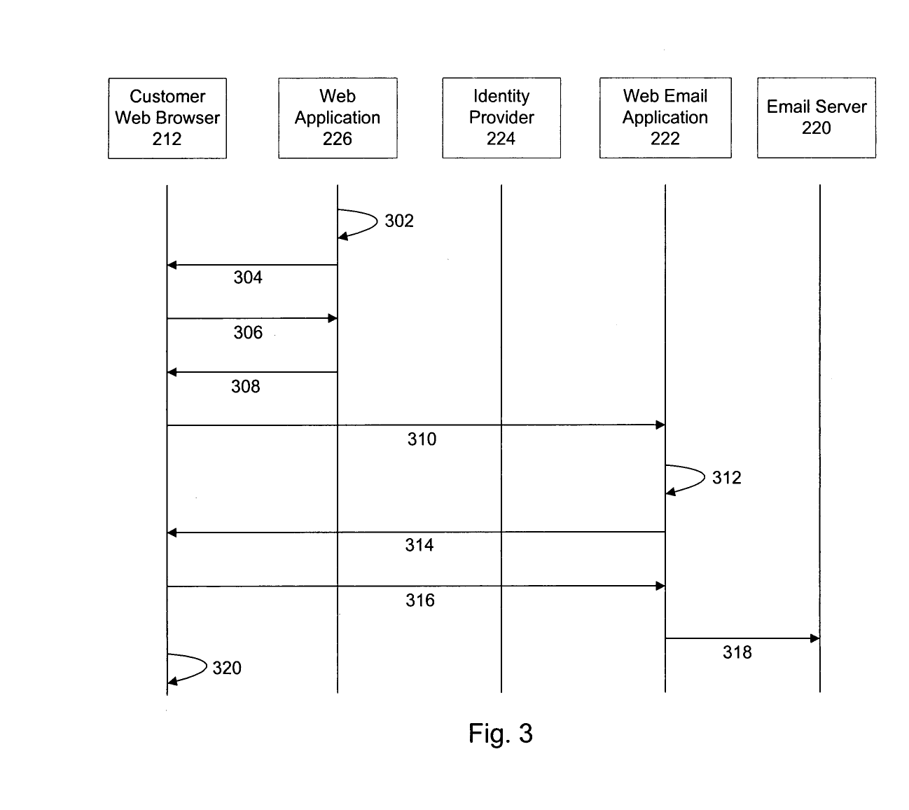

FIG. 3 generally depicts the click to email process with reference to the elements of FIG. 2. More particularly, FIG. 3 depicts an exemplary embodiment of the present disclosure in which the user of the web application 226, such as a VoIP application, accesses an affiliated web based email application, such as the web email application 222. The process begins at step 302, in which the web application 226 retrieves the click to email configuration settings. The web application 226 may retrieve the settings from a previously populated database, which may be an internal or external database. In an embodiment, the settings include, for example, the user's email address or email account, and indicate that the web based email program, provided by the web email application 222, is to be used with the click to email feature. The configuration settings will also indicate which affiliated web based email provider to use, including, for example, Yahoo, HotMail, Google, or the like.

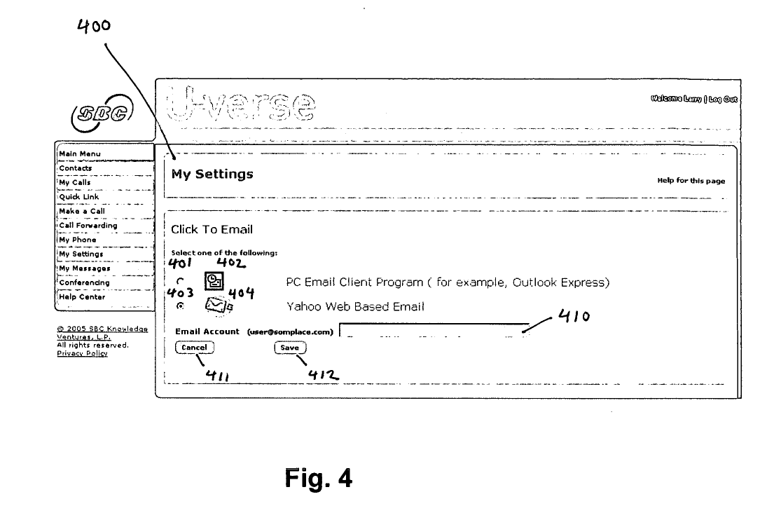

FIG. 4 depicts an exemplary screen shot 400, in which the user indicates configuration settings for the click to email service. The available settings include a first radio button 401 and a corresponding icon for a PC email client program 402, such as Microsoft Outlook, and a second radio button 403 and a corresponding icon for a web based email application 402, such as Yahoo. The icons are selected to be visually indicative of the respective email applications.

In the example depicted in FIG. 4, the radio button 403 is selected, indicating that the user has selected the web based email application (e.g., web email application 222) for the click to email implementation. Accordingly, the user must also enter his or her email account information in the email account field 410, so that the web based email application is able to generate appropriately addressed emails. The settings are saved by selection of the save button 412. Selection of the cancel button 411 cancels the currently displayed settings, reverting the configuration to the settings that were previously in place for the particular user.

Email account information is not needed whenever the PC email client program is selected, as this information is available at the PC email client running on the client 200. Therefore, in an embodiment, the field 410 and accompanying text are grayed out whenever the user selects the radio button 401. When the PC email client program is selected, a web page is generated using, e.g., HTML to launch the PC email client. For example, a link of the following form may be used for launching the PC email client: <a href=“mailto:user@domain”><img src=“email-icon.gif”></a>.

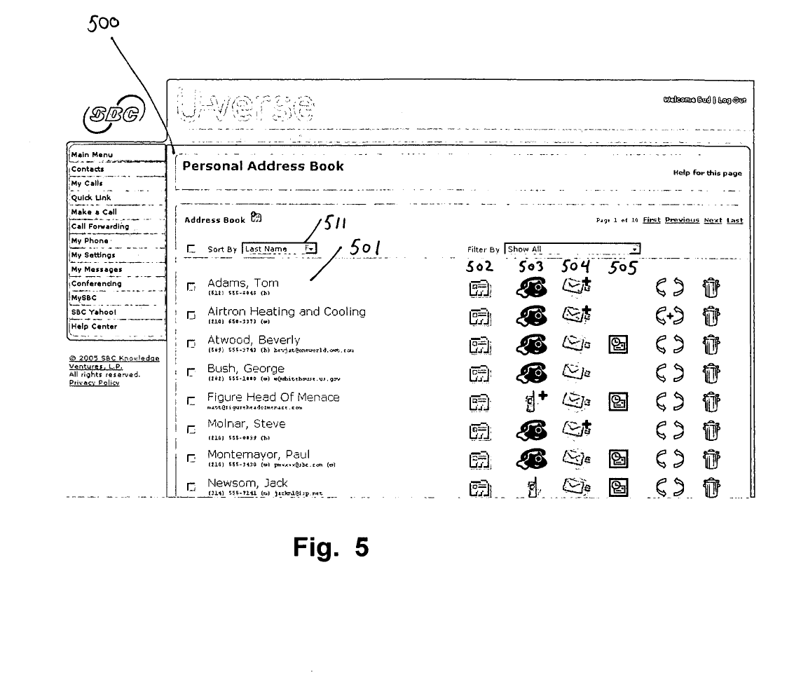

At step 304 of FIG. 3, the customer web browser 212 receives the HTML information, and renders a web page displayed at the client 200. FIG. 5 depicts an exemplary screen shot 500 of the displayed web page. The exemplary screen shot 500 provides information to enable the user to conveniently select the web based email application to create and send an email. More particularly, the screen shot 500 depicts a Personal Address Book, previously customized by the user. A list of contacts is displayed in column 501, which may include corresponding telephone numbers and email addresses. The list of contacts can be sorted by various criteria, including by name, as shown in the sort by field 511.

Column 502 provides icons depicting index cards, each of which will provide additional contact information corresponding to the contact names when selected by the user. Column 503 includes telephone icons, which may be included, for example, when the customer client application 210 and the web application 226 comprise a VoIP service, discussed above. In such an embodiment, clicking on one of the telephone icons in column 503 initiates a VoIP call to the corresponding contact listed in column 501.

The web based email application icons are depicted in column 504. The envelope icon is shown, as it corresponds to the envelope used by the Yahoo web based email service. Different icons, of course, may be incorporated to indicate different web based email service providers, without departing from the scope and spirit of the present disclosure. Also, multiple columns of email application icons offered by various providers may be included, when there is more than one available affiliated web based email service provider. Clicking on one of the envelope icons initiates the click to email feature of the present disclosure.

Screen shot 500 also includes an optional feature in column 505, which depicts Microsoft Outlook icons corresponding to certain contact entries. Column 505 thus depicts an alternative embodiment in which the user has a choice between a PC client based email program and a web based email program. Such a choice would be previously configured in the settings window of FIG. 4. Selection of the Microsoft Outlook icon results in an email being sent through the PC client based email program.

Referring again to FIG. 3, at step 306, the customer web browser 212 launches a new window with a uniform resource locator (URL) back to the web application 226 in response to the selection made by the user. For example, the user may click on one of the envelope icons in column 504 of FIG. 5 to send an email to the corresponding contact. The customer web browser 212 automatically launches a new browser window pointed at the web application 226 with instructions on initiating the requested email. In an embodiment, the URL used in the new browser window will vary by implementation, but will be of the following general form: “click/?To=user@domain.” The web application 226 executes the program referenced by the URL (e.g., “click”) with the invocation argument tag of “To” associated with the data, where “user@domain” is replaced with the intended recipient's email address.

At step 308, The web application 226 creates a redirect message, which is sent back to the customer web browser 212 to be used as the URL for accessing the web based email provider, e.g., the web email application 222. The redirect message may be encoded, and contains the data necessary for the customer web browser 212 to successfully initiate an email. For example, in one embodiment, the redirect encoded information includes the following: the action to be performed by the web email application 222 (e.g., launch an email compose window); an affiliate web site identifier (e.g., the web site identifier of a VoIP service); a GMT timestamp; and data needed by the web email application 222 to satisfy the request (e.g., the sender and recipient email addresses). In an embodiment, the redirect encoded information may also contain a digital signature having the results of applying a one-way hash algorithm, such as SHA-1 or MD-5, to concatenated parts of the redirect URL with a shared secret. For example, an encryption key may only be known by the web application 226 requesting the action and the network service (e.g., the VoIP service) responding to the requested action. The parts of the URL used for concatenation include at least the GMT timestamp value.

The redirect URL may vary in form, based on the implementation, but it follows the following general form for composing an email message: http://webemailprovider.com/Compose/From=“user@domain”&To=“user@domain”& Affiliate=“VoIP-Provider”&Timestamp=“20050911201325”&Signature=“39e9cce6825acc22b7026ac1ed17a7a49bae8a8d.” Referring to the exemplary redirect URL, webemailprovider.com/Compose is the URL of the form for composing email messages provided by the web based email provider; From=“user@domain” is the sender's email address, and To=“user@domain” is the intended recipient's email address; Affiliate is an identifier corresponding to the web application provider (e.g., the VoIP provider in this example) that uniquely identifies the web application that generated the redirect URL; the Timestamp is the time and date data, which should be included to assure security, as discussed below; and Signature is created using the shared secret “secret” and applying, for example, the one-way hash algorithm, as described above.

At step 310, the customer web browser 212 transfers the redirect URL to the web based email provider at the web email application 222. As discussed above, the URL contains information needed by the web email application 222 to process the email request.

At step 312, the web email application 222 determines whether the session is valid. The web email application 222 receives the HTTP request created at step 308 and received at step 310, and determines whether a valid session exists with the customer web browser 212. In one embodiment, this determination may be accomplished through a cookie exchange, although any session validation technique may be incorporated without departing from the scope and spirit of the present disclosure. A valid session indicates that the user is already logged in to the web email provider. After the session is validated at step 312, the web email application 222 parses and validates the information encoded in the redirect URL received at step 310.

When it is determined that there is not a valid session, the user will need to be authenticated. For example, the user may be authenticated using a user name and associated password. Alternatively, the user may be authenticated by using Federated Identity Management to obtain authentication from the same Identity Provider (IDP) that the web application provider uses, such as identity provider 224. Any other user authentication method may likewise be incorporated without departing from the scope and spirit of the present disclosure. When the user cannot be authenticated, an error message HTML page is sent to the user and displayed on the client 200.

In an embodiment, the session validation of step 312 may have two parts, for example, to avoid replay and other attacks. First, the GMT timestamp embedded in the URL may be compared to the current GMT time on the web email application 222. When the current time is outside a predefined window (e.g., typically less than one minute), the email request is rejected. An error message may then be returned to the user and displayed on the client 200. When the timestamp is within the predefined window, the processing continues. Second, the same parts of the URL previously agreed to be used for generating the digital signature (step 308) and concatenated with the shared secret are run through the same one-way hash algorithm used to generate the signature. When the locally computed signature matches the signature encoded in the URL, the request is considered valid. Otherwise, the processing branches to error handling (not shown).

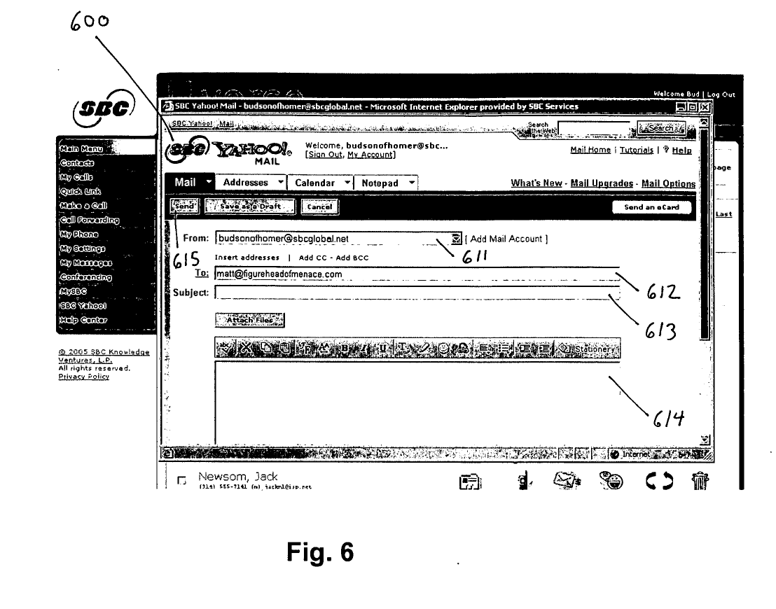

Once the request is validated, the web email application 222 performs the actions necessary to carry out the request. In an embodiment, the web email application 222 generates a compose web page, including an email compose window pre-addressed with the sender's and the intended recipient's email addresses, which is sent to the client 200 at step 314 for display. FIG. 6 shows a screen shot of an exemplary compose web page 600. As stated above, the sender's email address is automatically entered in the From field 611, and the intended recipient's email address is automatically entered in the To field 612. The Subject field 613 and the body of the message 614 are blank, and can be filled in by the user as desired. In the depicted embodiment, the compose web page 600 is an overlay or popup window that appears on top of the web page (e.g., screen shot 500 of FIG. 5) currently displayed at the client 200 by the web application 226. However, the format and manner in which the compose web page 600 is displayed may vary without departing from the scope and spirit of the present disclosure.

At step 316, the compose web, completed by the user, is submitted to the web email application 222. For example, the user may submit the web page 600 by clicking on the Send button 615 shown in FIG. 6. The web email application 222 packages the email and sends it through the email server 220 at step 318.

The web email browser of client 200 shuts down after the email is sent. The web application browser of the client 200 remains active, and, in the exemplary embodiment, the client 200 continues to display the screen shot 500 of FIG. 5. Accordingly, the user has created and sent an email using a web based email provider, without disturbing his or her active web application session, by simply clicking on an email icon displayed pursuant to the web application.

Although FIG. 3 depicts a particular sequence of steps, it is understood that the sequence is exemplary to an embodiment, and is not intended to be limiting. For example, in alternative embodiments, the order of the steps may differ, or the various steps may occur simultaneously, without affecting the scope and spirit of the disclosure. Also, although depicted linearly, the various embodiments may be implemented through various programming techniques with appropriate arrangements.

Although the present specification describes components and functions that may be implemented in particular embodiments with reference to particular standards and protocols, the invention is not limited to such standards and protocols. Each of the standards, protocols and languages represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope and spirit of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments that fall within the true spirit and scope of the present disclosure. Thus, to the maximum extent allowed by law, the scope of the invention is to be determined by the broadest permissible interpretation of the following claims and their equivalents, and shall not be restricted or limited by the foregoing detailed description.

Although several exemplary embodiments have been described, it is understood that the words that have been used are words of description and illustration, rather than words of limitation. Changes may be made within the purview of the appended claims, as presently stated and as amended, without departing from the scope and spirit of the invention in its aspects. Although the description refers to particular means, materials and embodiments, the invention is not intended to be limited to the particulars disclosed, but rather extends to all functionally equivalent structures, methods, and uses such as are within the scope of the appended claims.

What is claimed:

1. A computer readable medium that stores a program for sending an email through a web based email provider from a web application, the computer readable medium comprising:
a providing code segment that provides a web page of the web application to be displayed at a client of a user, the web page having at least one selectable link to the web based email provider;
a receiving code segment that receives an instruction requesting an email, the instruction being initiated by a selection of the at least one selectable link;
a creating code segment that creates a redirect message for accessing the web based email provider; and
a sending code segment that sends the redirect message to the client, which forwards the redirect message to the web based email provider to obtain an email composition web page.

2. The computer readable medium according to claim 1, further comprising:
a retrieving code segment that retrieves configuration settings from at least one of a database or the client, the configuration setting comprising an identification of the web based email provider.

3. The computer readable medium according to claim 1, in which the web application comprises a Voice over Internet Protocol (VoIP) application.

4. The computer readable medium according to claim 1, in which the web page of the web application comprises an address book.

5. The computer readable medium according to claim 4, in which the at least one selectable link corresponds to a contact listed in the address book.

6. The computer readable medium according to claim 5, in which the email composition web page comprises a sender field preaddressed with a sender email address of the user and a recipient field preaddressed with a recipient email address corresponding to the contact.

7. The computer readable medium according to claim 5, in which the web application comprises a Voice over Internet Protocol (VoIP) application, the web page of the web application further comprising a second selectable link corresponding to a telephone number of the contact listed in the address book.

8. The computer readable medium according to claim 7, further comprising:
a VoIP receiving code segment that receives a VoIP instruction from the client requesting a telephone connection to the contact by a selection of the second selectable link; and
a VoIP initiating code segment that initiates the telephone connection to the contact in response to the VoIP instruction.

9. A system for sending an email through a web based email provider while using a web application, the system comprising:
a web application server that displays a web page at a graphical user interface (GUI) having at least one selectable link, receives an instruction requesting an email through selection of the at least one selectable link, creates a redirect message for accessing the web based email provider, and sends the redirect message to the GUI; and
a web based email application server that receives the redirect message from the GUI, displays an email composition web page at the GUI, receives a completed email, and sends the completed email to an email server for delivery.

10. The system according to claim 9, in which the web application server further retrieves at least one configuration setting from a database, the at least one configuration setting comprising an identification of the web based email provider.

11. The system according to claim 9, in which the web page of the web application comprises a list of contacts, and in which the at least one selectable link corresponds to an email address of one of the listed contacts.

12. The system according to claim 11, in which the web application comprises a Voice over Internet Protocol (VoIP) application, the web page of the web application further comprising a second selectable link corresponding to a telephone number of one of the listed contacts.

13. The system according to claim 11, in which the email composition web page comprises a sender field preaddressed with a sender email address and a recipient field preaddressed with a recipient email address corresponding to the contact.

14. The system according to claim 9, further comprising:
an authentication server that provides authentication data corresponding to the web application and the web based email application.

15. The system according to claim 14, in which the authentication server enables single sign-on capability for the web application and the web based email application.

16. A method for sending an email through a web based email provider, while using a web application, the method comprising:
providing a web page of the web application to be displayed at a graphical user interface of a client of a user, the web page having at least one selectable link to the web based email provider;
receiving an instruction requesting an email, the instruction being initiated by a selection of the at least one selectable link;
creating a redirect message for accessing the web based email provider; and
sending the redirect message to the client, which forwards the redirect message to the web based email provider to obtain an email composition web page.

17. The method according to claim 16, further comprising:
retrieving configuration settings from at least one of the client and a database, the configuration settings comprising an identification of the web based email provider.

18. The method according to claim 16, in which the at least one selectable link corresponds to a contact listed on the web page.

19. The method according to claim 18, in which the web application comprises a Voice over Internet Protocol (VoIP) application.

20. The method according to claim 19, in which the web page of the web application further comprises at least one VoIP selectable link corresponding to a telephone number of the contact listed on the web page, the method further comprising:
initiating a telephone connection to the contact in response to selection of the at least one VoIP selectable link.
